(19) United States
(12) Patent Application Publication
(10) Pub. No.: US 2008/0257477 A1
(43) Pub. Date: Oct. 23, 2008

(54) Non-Shrink High Viscosity Chemical Grout

(76) Inventor: Sang-Woon Kwak, Seoul (KR)

Correspondence Address: CANTOR COLBURN, LLP, 20 Church Street, 22nd Floor, Hartford, CT, 06103, US

(21) Appl. No.: 10/529,801

(22) PCT Filed: Oct. 2, 2003
(86) PCT No.: PCT/KR2003/002031

§ 371 Date: Jul. 16, 2007

(30) Foreign Application Priority Data
Oct. 2, 2002 (KR) 10-2002-0060225

(51) Int. Cl. C08K 3/40; B05D 3/00; B32B 43/00

(52) U.S. Cl. 156/98; 524/612; 524/494; 427/140; 427/142

(57) ABSTRACT

The present invention relates to a non-shrink high viscosity chemical grout composition, more particularly to a non-shrink high viscosity chemical grout composition comprising, on the basis of solid content, a) 100 parts by weight of a room temperature curable organic liquid phase resin; b) 10 to 200 parts by weight of glass beads; and c) 10 to 500 parts by weight of glass powder. In addition, the present invention relates to a method for repairing and reinforcing a construction using the non-shrink high viscosity chemical grout composition. The non-shrink high viscosity chemical grout composition of the present invention has superior acid resistance, alkali resistance, injection property, fluidity, crack resistance, impact resistance, adhesion property and storage property, and the method for repairing and reinforcing a construction of the present invention has affinity with subsidiary materials, can completely restore function and shape of a construction in short time due to rapid curing and simple construction, compensates properties of construction such as tensile strength, allows strong adhesion to a construction, and prolongs lifetime of a construction.

### BACKGROUND OF THE INVENTION

(a) Field of the Invention

The present invention relates to non-shrink high viscosity chemical grout, particularly to non-shrink high viscosity chemical grout having superior acid resistance, alkali resistance, injection property, fluidity, impact resistance, crack resistance, adhesion property and storage property. And, the present invention relates to a method for repairing and reinforcing a construction using the non-shrink high viscosity chemical grout.

(b) Description of the Related Art

Grout is an injection material that is injected into cracks or hollows of the ground in order for soil stabilization or water leakage prevention work.

The injection material is filled using gravity or a pump, and it is used to reinforce support force of an axis or pedestal part of a construction or repair cracks of a construction.

Grout is classified into standing water grout, ground improving grout, filling grout, reinforcing grout, etc. according to its construction purposes, hollow grout, pore grout, etc. according to injected parts, and cement grout, ferrous grout, asphalt grout, chemical grout, etc. according to its main ingredient.

If cracks of a construction are left, appearance of the construction is damaged, and the cracks grow worse to cause water leakage, containment, corrosion of placed steel reinforcing therefore shortening of lifetime and collapse of a construction. Therefore, appropriate repair and reinforcement is required.

Cracks are caused by inappropriate use of material, problems of construction, or use and external environment, and they appear in various forms according to its causes.

Conventionally, asphalt grout has been used for standing water and soil stabilization, and ferrous grout has been used for filling reinforcement of a filling or a joint of steel-frame foundation due to its chemical non-shrinkage and high strength.

Initially, cement grout comprising cement, water, clay, etc. was predominantly used, but chemical grout was developed in the year of 1919 and thus has been predominantly used thereafter.

Recently, technologies relating to chemical grout were rapidly developed due to discovery of vinyl polymer or chrome lignin, and such chemical grout has been predominantly used for improvement of standing water or ground and repair and reinforcement of a construction.

Among the conventional chemical grout, one comprising an epoxy resin as a main component and sodium silicate as filling additive is most widely used. However, the chemical grout comprising an epoxy resin as a main component has problems in that the sodium silicate filler is not uniformly dispersed and thus cannot function as a filler, strength of the grout decreases, and adhesion between cracks decreases to generate cracks again, because of high absorption force of sodium silicate added as filler for a resin.

In addition, when the conventional grout comprising an epoxy resin and sodium silicate is injected into cracks, the grout cannot be easily injected because of bubbles in the cracks. Particularly, in the case of a pipe or crack with narrow width, the injection of grout is critically blocked by bubbles. And, the grout is absorbed into a mother construction or cured and shrink, and thus it cannot be completely filled in cracks.

Moreover, the conventional repair and reinforcement method of a construction is complicated, requires long time until the construction is normalized after recovery, cannot completely recover damaged appearance, and frequently generates cracks again.

### SUMMARY OF THE INVENTION

The present invention is made in order to solve the above problems, and it is an object of the present invention to provide chemical grout that has superior acid resistance, alkali resistance, injection property, impact resistance, crack resistance, adhesion property and storage property, and can be used for underwater work.

It is another object of the present invention to provide a method for repairing and reinforcing a construction, which has affinity with material of a construction, can completely recover the function and the shape of a construction within a short time due to a simple construction work and rapid curing, compensates physical properties of a construction such as tensile strength, etc. and allows strong adhesion to a construction to prolong the lifetime of a construction, and completely recover damages appearance.

In order to achieve these objects, the present invention provides non-shrink high viscosity chemical grout comprising, on the basis of solid content, a) 100 parts by weight of a room temperature curable organic liquid phase resin; b) 10 to 200 parts by weight of glass beads; and c) 10 to 500 parts by weight of glass powder.

The present invention also provides a method for repairing and reinforcing a construction using the non-shrink high viscosity chemical grout.

### BRIEF DESCRIPTION OF THE DRAWINGS

FIG. 1 is photographs showing whether or not concrete cracks remain after injecting chemical grout prepared by Example 1 and Comparative Example 1.

FIGS. 2 to 5 are photographs of containers holding water, into which a brick was put, and then the chemical grout prepared by Example 1 and Comparative Example 1 was injected on the upper part thereof.

### DETAILED DESCRIPTION OF THE PREFERRED EMBODIMENTS

The present invention will now explained in detail.

The non-shrink high viscosity chemical grout of the present invention is characterized by adding glass beads and glass powder as fillers to a resin that is widely used as a main component of the conventional non-shrink high viscosity chemical grout.

The non-shrink high viscosity chemical grout of the present invention comprises a) a room temperature curable liquid phase resin as a main component. As the room temperature curable liquid phase resin, an epoxy-based, an acryl-based, a urethane-based, an alkyd-based, a polyester-based, or a polyvinylchloride-based resin, etc. is preferable. As the epoxy based resin, non-solvent or solvent diluting epoxy resin having a molecular weight of 350 to 3,000 MW of diglycidyl or triglycidyl type are preferable. As the acryl based resin, a solvent type acryl urethane comprising methacrylic acid derivative as a main component, aqueous acrylhydrosol, emulsion non-solvent type acryl silane, or UV curable acryl, etc. are preferable. As the alkyd based resin, paint type alkyd resins modified with polybasic acid and polyhydric alcohol ester compound are preferable, and those modified with rosin, phenol, epoxy, vinyl styrene monomer, isocyanate or silicon, etc. can be used.

As the polyvinyl chloride based resin, a plastic sol liquid phase resin of PVC is preferable.

In addition, unlikely to the conventional urethane based grout, the room temperature curable organic liquid phase resin does not have foaming (expanding) property due to high specific gravity of glass beads and glass powder added as essential ingredients. Therefore, the injection of the non-shrink high viscosity chemical grout of the present invention can solve the problem of the prior art that cracks may be worsen because of expanding property of grout.

The room temperature curable organic liquid phase resins function as binders that provide adhesion properties to cement, concrete, etc. adhered to cracks or hollow into which non-shrink high viscosity chemical grout is injected, and they provide acid resistance and alkali resistance to the non-shrink high viscosity chemical resistance.

If the content of the room temperature curable organic liquid phase resin is too low, adhesion property to cement, concrete, etc. is insignificant, and if the content is too high, the content of a filer additive glass powder comparatively decreases to deteriorate physical properties of grout such as strength or hardness.

The non-shrink high viscosity chemical grout of the present invention comprises b) glass beads. The glass beads include spherical, oval or similar shaped glass beads, and those having various sizes and those having specific size.

The content of the glass beads are preferably 10 to 200 parts by weight, based on 100 pats by weight of solid content of the room temperature curable organic liquid phase resin, more preferably 100 to 200 parts by weight, most preferably around 150 parts by weight.

If the content of the glass beads is less than 10 parts by weight, fluidity of the non-shrink high viscosity chemical grout decreases, and strength and hardness thereof decreases after cured. And, if the content is more than 200 parts by weight, the content of the room temperature curable organic liquid phase resin decrease to lower strength of the non-shrink high viscosity chemical grout and the non-shrink high viscosity chemical grout may be lost after cured. The content of the glass beads are more preferably 100 to 200 parts by weight, in terms of processibility and physical properties.

The content of glass beads is preferably high in case cracks are large, and low in case gaps between cracks are narrow.

The particle size of the glass beads are suitably selected according to construction purpose and thickness. The particle diameter of the glass bead is preferably 200 mesh to 3 mm. If a glass bead having particle diameter of less than 200 mesh is used, volume filling property and impact resistance decrease. And, if a glass bead having particle diameter of more than 3 mm is used, dispersity decreases or it cannot be efficiently used for cracks of size of 3 mm or less.

Since the glass bead is almost spherical, it provides high fluidity to the non-shrink high viscosity chemical grout, and provides superior storage property such that a mixture of a resin and filler additives are well mixed by simple agitation even after stored for a long time.

In addition, since the glass bead has higher strength than sodium silicate and is almost spherical, it absorbs and disperses external impact. Therefore, the non-shrink high viscosity chemical grout of the present invention to which glass beads are added as a filer has superior impact resistance.

The non-shrink high viscosity chemical grout of the present invention comprises c) glass powder. The glass powder increases viscosity of the chemical grout to increase impact resistance and tensile force, and it inhibits contraction and expansion.

As the glass powder, those of various particle shapes and sizes can be used. The glass powder is obtained by milling a common glass, and its composition is not specifically limited so long as compatible with resin such as A, C, E, alkali resistant glass powder composition.

The content of the glass powder is 10 to 500 parts by weight, based on 100 parts by weight of solid content of the room temperature curable organic liquid phase resin, more preferably 20 to 80 parts by weight, and most preferably around 50 parts by weight. If the content of the glass powder is les than 10 parts by weight, viscosity of the grout decreases and contraction and expansion rate increases after cured. And, if the content of the glass powder is more than 500 parts, by weight, viscosity is too high and thus the chemical grout is difficult to be injected into cracks, and the content of the room temperature organic liquid phase resin comparatively decreases to decrease strength of the chemical grout.

Therefore, considering size of cracks, depth of cracks and the content of impurities such as bubbles between cracks, in case injected into deep cracks, it is preferable to decrease the content of the glass powder to make grout having superior fluidity and injection property.

Since the glass powder does not absorb resin unlikely to silica or silicate, it can be added to a non-shrink high viscosity chemical grout in a large amount, and even the content of the glass powder is high, it is well mixed and dispersed in the room temperature organic liquid phase resin and volume filling property is superior.

In case a grout is injected at low temperature, the content of the glass powder can be decreased to lower viscosity of the grout, and in case a grout is injected at high temperature, the content of the glass powder can be increased to increase viscosity.

The particle diameter of the glass powder is preferably 10 μm to 1 mm, and it is preferable to use glass powder having smaller particle diameter than glass bead because it functions for filling pores between glass beads.

If the particle diameter of the glass powder is less than 10 μm, viscosity of the chemical grout largely increases, and if the particle diameter of the glass powder is more than 1 mm, its function for filling pores between glass beads deteriorates and thus strength of the chemical grout decreases or contraction and expansion increases.

The non-shrink high viscosity chemical grout comprising a) a room temperature curable organic liquid phase resin; b) glass beads; and c) glass powder is preferably used for relatively large cracks having crack interval of more than 5 mm.

The non-shrink high viscosity chemical grout can further comprise milled glass fiber. If the glass fiber is added, tensile force and crack resistance of cured grout increase.

The glass fiber is preferably a long glass fiber of E composition, and those of alkali resistant composition can also be used. The glass fiber is a chopped fiber prepared by cutting a glass fiber having fiber diameter of 10 to 20 μm to a uniform strand length, or a milled fiber prepared by milling the glass fiber to an average fiber length. The chopped fiber is preferably cut to a fiber length of 2 to 12 mm, and the milled fiber preferably has average fiber length of 100 to 300 μm.

The content of the glass fiber is preferably 1 to 50 parts by weight, based on 100 parts by weight of room temperature curable liquid phase resin. If the content of the glass fiber is less than 1 part by weight, tensile strength of cured grout decreases, cracks are generated, and contraction and expansion increase. And, if the content is more than 50 parts by weight, mixing and dispersion are difficult. More preferably, the content of the glass fiber is 1 to 10 parts by weight.

The non-shrink high viscosity chemical grout of the present invention has superior fluidity but in order to easily inject into cracks of cement, concrete, etc., solvent such as benzyl alcohol can be further added thereto.

In addition, the non-shrink high viscosity chemical grout of the present invention can further comprise curing agent, cure promoter, etc. The curing agent and the cure promoter can be selected according to the kinds and amount of resin, and it amount is determined considering the kinds and conditions of cracks into which the chemical grout is injected.

The non-shrink high viscosity chemical grout of the present invention has viscosity of 1000 to 20000 cps, which is higher than conventional grout comprising an epoxy resin as a main component and sodium silicate as filler. In case the non-shrink high viscosity chemical grout comprises a glass fiber, the viscosity is preferably 15000 to 20000 cps. And, since the chemical grout of the present invention comprises almost spherical glass beads as essential component, it has superior fluidity despite its high viscosity and thus can be injected into deep part of cracks that is blocked by impurities such as bubbles.

Accordingly, the non-shrink high viscosity chemical grout of the present invention has superior injection property and thus it can be easily injected into deep part of cracks when injected into cracks by known method such as using a syringe or a pump.

As explained, the non-shrink high viscosity chemical grout of the present invention has superior acid resistance, alkali resistance, injection property, fluidity, impact resistance, crack resistance and storage property.

In addition, the present invention provides a method for repairing and reinforcing a construction using the non-shrink high viscosity chemical grout.

Specifically, the repair or reinforcement is conducted by coating the non-shrink high viscosity chemical grout on the surface of a construction, filling or injecting it into cracks of a construction, using it as an adhesive when reinforcement is integrated into a construction, impregnating a carbon fiber into the chemical grout to integrate into a construction, or using the above methods in combination.

The method for repairing and reinforcing a construction can be suitably selected according to its purpose, cause of cracks, shape and size of cracks, importance of a construction, structure of a construction, environmental conditions, and the life of a construction after repaired.

A surface coating, one of the methods for repairing and reinforcing a construction, is preferable in case crack width is 0.2 mm or less, and it is useful for improving waterproofing property and durability. It is conducted by cleaning the surface of a part to be reinforced or around cracks of a construction, coating the desired part with the non-shrink high viscosity chemical grout of the present invention and then curing to form a coating film. The surface coating method using the non-shrink high viscosity chemical grout of the present invention improves repairing effects, because the chemical grout has high viscosity and good fluidity and thus moves down the cracks, and finish-repairing work can be simply conducted without cure shrinkage on the upper part of cracks after primary surface repair. In addition, since it does not shrink in cracks and has good filling effects, the non-shrink high viscosity chemical grout moved down the cracks applies tensile force in three dimensions to prevent regeneration of cracks. Thus the present invention solves the problems of the prior art that an tensile-force reinforcing tape is adhered to the upper part of cracks and finished with a resin, and thus traces of material appear, cracks are frequently regenerated, and surface coating is difficult in the case of irregular shaped cracks.

The injection method is suitable for repairing cracks having width of 0.2 to 1 mm and loose parts, and is conducted by injecting the chemical grout into desired part. The injection method includes mechanical injection, manual injection, pedal type injection, inflow method, etc., and it can be suitably selected by an ordinary skilled person. As one example, in the case of repairing a construction having non-penetrated cracks of width of 0.5 mm, an injection pack is installed on the upper part of cracks to inject the chemical grout of the present invention by free fall due to gravity or by applying pressure into the upper part of cracks, removing the injection pack and then finish-treating the cracked surface, and in the case of penetrated cracks, a reinforcing film is installed on one side of the penetrated cracks and then the above processes are conducted.

According to the method for repairing and reinforcing a construction by injection, the chemical grout infiltrates the mother construction to a depth of 10 to 20 mm to reinforce the strength of mother construction, passes through bubbles and water in closed cracks to reach deep part of cracks well, is cured while compensating tensile strength of mother construction thus preventing regeneration of cracks, is elastic to temperature change, and does not show shrinkage when cured.

The filling method is preferable in case a construction has crack width of more than 0.5 mm, and has corroded internal steel reinforcing. The filling of the present invention is conducted by cleaning a part to be filled and filling the non-shrink high viscosity chemical grout into the part to be filled using a common method without a separate pre-treatment. Conventionally, in case steel reinforcing in a construction is corroded, the construction was cut to U or V shape to a depth where the steel reinforcing is placed, a separate rust preventing treatment is conducted, and then filler is introduced and mortar plastering is conducted. However, according to the filling of the present invention, a construction can be repaired and reinforced by a simple work because the chemical grout simultaneously functions as rust inhibitor, finish line work is precisely conducted and adhesion surface is not lost after cured because the chemical grout is non-shrink type, the effects of anticorrosion, water proof property, neutralization prevention as well we rust prevention can be simultaneously obtained by conducting a filling once, construction work is also possible underwater and under humid environment, a construction can be rapidly restored to the original state due to rapid curing, and progression of cracks can be prevented for progressive cracks.

In addition, the method of using the grout as an adhesive, when reinforcement is integrated into a construction, can be applied in case cross-sectional installation by reinforcement is required and preventions of deterioration of concrete and corrosion of steel reinforcement are required. Particularly, according to the present invention, the non-shrink high viscosity chemical grout replaces the conventional adhesive resin to prevent formation of hollow between the construction and the reinforcement in work place, thereby contributing to reliability of work. The reinforcement includes steel plate, steel reinforcing, H type steel, I type steel, etc. and its adhesion method includes compression, injection, etc.

In addition, the method of impregnating a carbon fiber into the non-shrink high viscosity chemical grout to integrate into a construction improves load resistance of material receiving shear stress, and tensile forces and bending forces of bottom of steel reinforcing concrete slab and bottom and side of a girder. And, the method is useful for reinforcing earthquake resistance of pier and repair and reinforcement of a tunnel and box culvert.

The carbon fiber used in the present invention includes a thread type and a carbon fiber sheet prepared by arranging carbon fiber in one direction, and preferably a carbon fiber sheet is used in terms of convenience in construction work. The method for repairing and reinforcing a construction using the carbon fiber comprises the steps of impregnating the carbon fiber into the non-shrink high viscosity chemical grout and pulling it up, and then adhering and curing it to a direction of main reinforcing of a construction. This method minimizes formation of hollow between the carbon fiber sheet and the original construction due to the inherent advantages of carbon fiber such as high strength, light weight, easy operation, high durability, etc. and the advantages of the non-shrink high viscosity chemical grout having high adhesion property, and compensates tensile force that is disadvantage of carbon fiber to maximize repair and reinforcement effects.

And, it is more preferable in terms of convenience in work that the carbon fiber is impregnated into the non-shrink high viscosity chemical grout and previously cured to prepare a panel, and then the panel is adhered to a construction using the non-shrink high viscosity chemical grout.

In addition, the method for repairing and reinforcing a construction using the non-shrink high viscosity chemical grout can be effectively used for repair and reinforcement of cracks of underwater or submerged construction, because grout does not get dissolved in water, is not absorbed to the mother construction, strongly adheres thereto and injected, filled or coated on the surface thereof. And, the non-shrink high viscosity chemical grout of the present invention can be injected, filled or coated to repair and reinforce bottom part of a ship.

The present invention will be explained in more detail with reference to the following Examples. However, these are only to illustrate the present invention and the present invention is not limited to them.

### EXAMPLES

### Example 1

### Preparation of Non-Shrink High Viscosity Chemical Grout

1 kg of epoxy liquid phase resin (Kuk-do chemicals YD-128) and 20 g of alcohol were mixed, 1 kg of glass beads with average particle size of 1 mm (Jisan Industry) and 500 g of glass powder having an average particle size of 200 mesh and specific gravity of 2.54 (Kumyoong Industry) were added thereto, and they were mixed in a common mixer to prepare a non-shrink high viscosity chemical grout.

The prepared non-shrink high viscosity chemical grout had specific gravity of 1.3 and fluidity of 50 cm as result of slump test. The grout is put in a steel can and stored at room temperature for 12 months, and then opened. As results, it was observed that a part of the fillers are precipitated but not solidified, and shaking of the can allowed uniform dispersion of the fillers.

### Comparative Example 1

Grout comprising epoxy main component (transparent liquid phase, Youngji Precision Industry) and epoxy curing agent (modified aliphatic amine type, brown liquid phase (Youngji Precision Industy) in a ratio of 2:1 was used. The grout has viscosity of 220 cps and specific gravity of 1.15.

### Injection Property Test

The non-shrink high viscosity chemical grout prepared in Example 1 and Comparative Example 1 was injected into cracks of concrete and it was observed whether or not cracks remain.

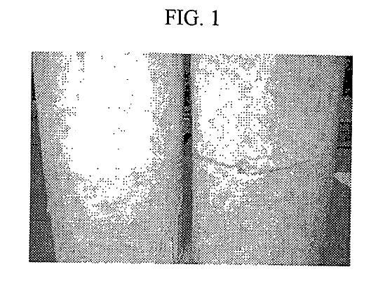

FIG. 1 shows whether or not concrete cracks remain after the chemical grout prepared in Example 1 and Comparative Example 1 were injected.

As shown in FIG. 1, when the chemical grout of Example 1 was injected (the left side of FIG. 1), concrete cracks disappeared such that they are not identified with naked-eyes. However, when the chemical grout of Comparative Example 1 was injected (the right side of FIG. 1), concrete cracks still remained.

It is believed to result from the fact that the non-shrink high viscosity chemical grout has superior fluidity and high specific gravity because it essentially comprises glass beads and glass powder, and thus it is filled into a construction while pushing out bubbles.

### Adhesion Test

The non-shrink high viscosity chemical grout of Example 1 and Comparative Example 1 were injected into concrete cracks, and after 24 hours, physical force was applied to both ends of concrete cracks to separate the cracks.

As results, both ends of concrete into which the grout of Comparative Example 1 was injected was easily separated, but both ends of concrete into which the grout of Example 1 was injected was not easily separated and the concrete construction itself was separated into two parts.

It is believed to result from the fact that, despite of high adhesion force of 17 kg/cm2 of concrete, the non-shrink high viscosity chemical grout has higher adhesion force of 36 to 90 kg/cm2 than concrete.

### Underwater Work Test

In order to examine whether or not repair and reinforcement using the non-shrink high viscosity chemical grout of the present invention can be efficiently conducted, underwater work test was conducted.

A cement brick having cracks was put in a container holding water, and then the grout of Example 1 and Comparative Example 1 were injected into the upper part, and the conditions were observed.

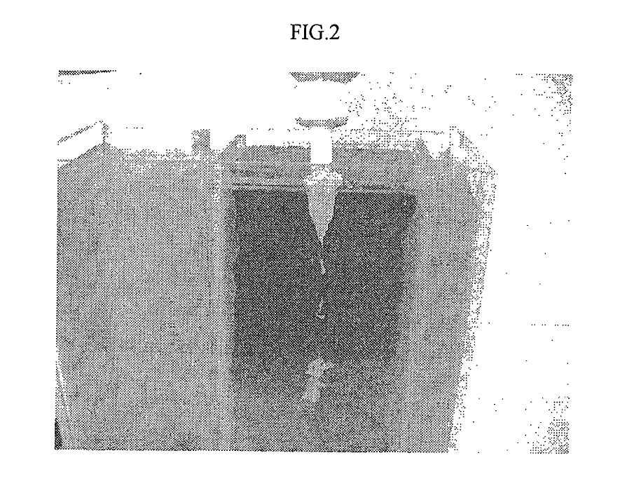

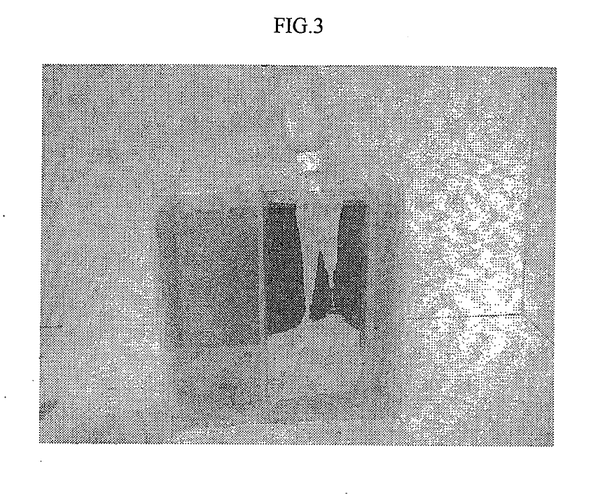

FIGS. 2 and 3 show that the grout of Example 1 did not get dissolved underwater, was not absorbed to mother brick and strongly adhered thereto. Thus it can be seen that the non-shrink high viscosity chemical grout of the present invention can be effectively applied for repair and reinforcement of a construction and a ship even underwater.

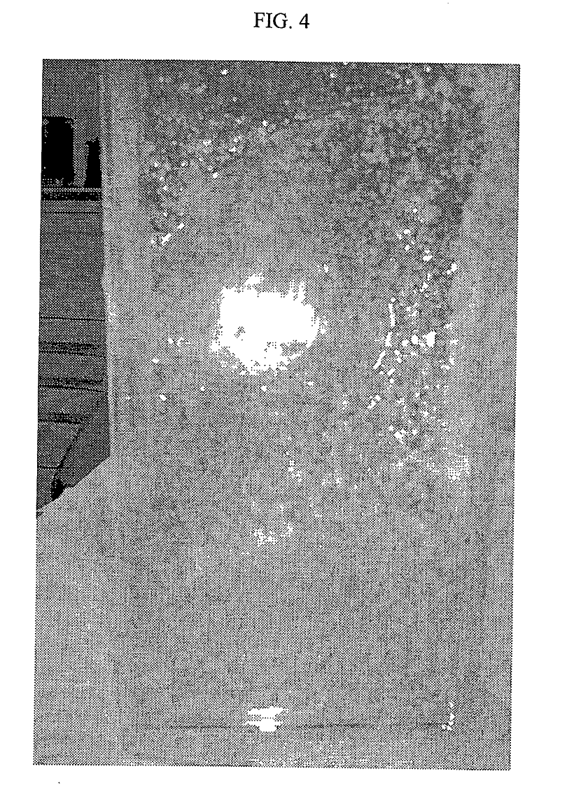

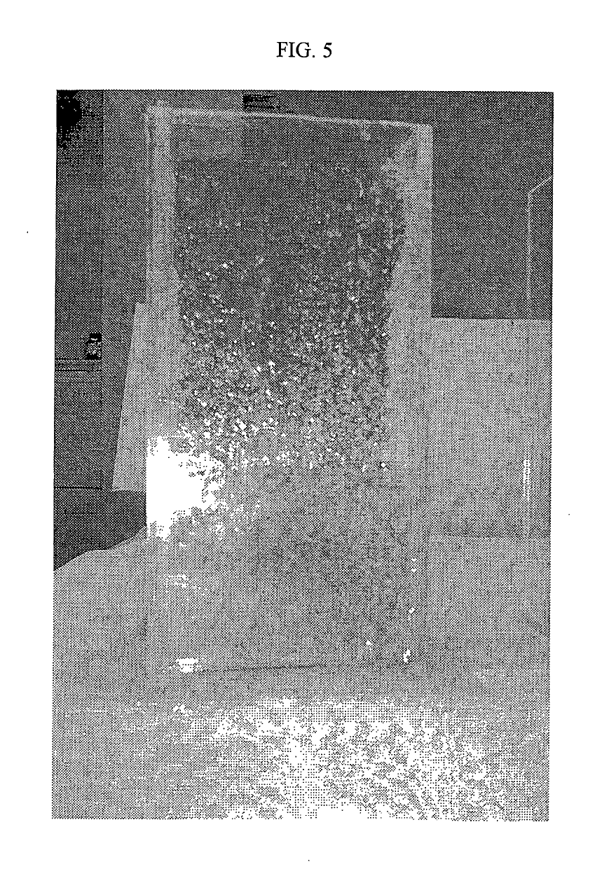

Meanwhile, FIGS. 4 and 5 show that the grout of Comparative Example 1 got dissolved in water, was absorbed to mother brick and thus it was not suitable for repair and reinforcement of underwater construction.

The non-shrink high viscosity chemical grout of the present invention has superior acid resistance, alkali resistance, injection property, fluidity, impact resistance, crack resistance, adhesion property and storage property.

In addition, the method for repairing and reinforcing a construction of the present invention uses the non-shrink high viscosity chemical grout and thus has affinity with material, completely restore functions and shape of a construction within a short time due to simple construction work and rapid curing, compensates physical properties of a construction such as tensile force, strongly adheres to a construction to prolong lifetime of a construction, and completely restores damaged appearance.

1. A non-shrink high viscosity chemical grout comprising:
on the basis of solid content,
a) 100 parts by weight of a room temperature curable organic liquid phase resin;
b) 10 to 200 parts by weight of glass beads; and
c) 10 to 500 parts by weight of glass powder.

2. The non-shrink high viscosity chemical grout according to claim 1, wherein the a) room temperature curable organic liquid phase resin is selected from the group consisting of an epoxy based resin and a polyurethane based resin.

3. The non-shrink high viscosity chemical grout according to claim 2, wherein the epoxy based resin is a non-solvent or solvent diluting epoxy resin having molecular weight of 350 to 3000 MW of diglycidyl type or triglycidyl type.

4. The non-shrink high viscosity chemical grout according to claim 1, wherein the b) glass beads have particle diameter of 200 mesh to 3 mm.

5. The non-shrink high viscosity chemical grout according to claim 1, wherein the c) glass powder has particle diameter of 10 μm to 1 mm.

6. The non-shrink high viscosity chemical grout according to claim 1, wherein the grout has viscosity of 1000 to 20000 cps.

7. A non-shrink high viscosity chemical grout comprising the components of the non-shrink high viscosity chemical grout according to claim 1, and, on the basis of 100 parts by weight of the a) room temperature curable organic liquid phase resin, d) 1 to 50 parts by weight of glass fiber.

8. The non-shrink high viscosity chemical grout according to claim 7, wherein the d) glass fiber is a chopper fiber prepared by cutting a long glass fiber of E-glass composition to a length of 2 to 12 mm, or a milled fiber prepared by milling the same to a length of 100 to 300 μm

9. The non-shrink high viscosity chemical grout according to claim 7, wherein the chemical grout has viscosity of 15000 to 20000 cps.

10. A method for repairing and reinforcing a construction, which uses the non-shrink high viscosity chemical grout of claim 1.

11. The method for repairing and reinforcing a construction according to claim 10, which comprises the steps of cleaning the surface of a part to be reinforced or around cracks of a construction, coating the surface with the non-shrink high viscosity chemical grout, and curing the coated surface to form a coating film.

12. The method for repairing and reinforcing a construction according to claim 10, which comprises the steps of installing an injection pack on the upper part of cracks of a construction to inject the non-shrink high viscosity chemical grout on the upper part of cracks by free fall caused by gravity or by applying pressure, removing the injection pack, and finish-treating the cracked surface.

13. The method for repairing and reinforcing a construction according to claim 10, wherein a part of a construction to be filled is cleaned and then filled with the non-shrink high viscosity chemical grout.

14. The method for repairing and reinforcing a construction according to claim 13, wherein the construction has cracks having width of 0.5 mm or more, or corroded inner steel reinforcing, and a part to be filled is filled with the non-shrink high viscosity chemical grout without conducting a separate U or V type cutting.

15. The method for repairing and reinforcing a construction according to claim 10, wherein reinforcement is integrated into the construction, and the non-shrink high viscosity chemical grout is used as an adhesive.

16. The method for repairing and reinforcing a construction according to claim 10, wherein a carbon fiber is impregnated into the non-shrink high viscosity chemical grout and then pulled up, and adhered and cured to a direction of main reinforcement of a concrete.

17. The method for repairing and reinforcing a construction according to claim 10, wherein a carbon fiber is impregnated into the non-shrink high viscosity chemical grout and cured to prepare a panel, and the panel is adhered to a construction.

18. The method for repairing and reinforcing a construction according to claim 10, wherein a damaged part of an underwater or submerged construction is restored with the non-shrink high viscosity chemical grout.

19. A method for repairing and reinforcing a bottom of a ship, which uses the non-shrink high viscosity chemical grout according to claim 1.

20. A method for repairing and reinforcing a construction, which uses the non-shrink high viscosity chemical grout of claim 9.

21. A method for repairing and reinforcing a bottom of a ship, which uses the non-shrink high viscosity chemical grout according to claim 9.
